(19) United States
(12) Patent Application Publication
(10) Pub. No.: US 2026/0266231 A1
(43) Pub. Date: Sep. 10, 2026

(54) METHOD FOR OPERATING AN INTERNAL COMBUSTION ENGINE WITH GASEOUS FUEL, COMPUTER PROGRAM PRODUCT AND CONTROL UNIT

(71) Applicant: Robert Bosch GmbH, Stuttgart (DE)

(72) Inventors: Alexander Schenck Zu Schweinsberg, Moeglingen (DE); Christian Disch, Wimsheim (DE); Eva Prospero, Renningen (DE); Japhet Ruthardt, Ludwigsburg (DE); Markus Amler, Leonberg-Gebersheim (DE); Michael Brotz, Stuttgart (DE); Petra Manner, Gerlingen (DE); Timm Hollmann, Benningen A.N. (DE)

(21) Appl. No.: 19/443,107

(22) Filed: Jan. 8, 2026

(30) Foreign Application Priority Data
Jan. 16, 2025 (DE) 10 2025 101 470.1

(51) Int. Cl. F02D 41/00

(52) U.S. Cl. CPC F02D 41/0027; F02D 2200/0602; F02D 2200/0614

(57) ABSTRACT

In a method for operating an internal combustion engine having a plurality of combustion chambers, gaseous fuel is supplied by means of an injection from a fuel rail and via a fuel injector assigned to a particular combustion chamber, and gaseous fuel is supplied to the fuel rail substantially continuously from a fuel supply system. The method includes the following steps: ascertaining, within at least one operating cycle, the pressure drops of the pressure in the fuel rail that respectively occur during an injection into a combustion chamber; ascertaining the open durations, assigned to the respective pressure drop, of the corresponding fuel injector; ascertaining the total duration of the operating cycle; ascertaining respective mass indicators from the ascertained pressure drops, the ascertained open durations and the ascertained total duration.

### CROSS REFERENCE

The present application claims the benefit under 35 U.S.C. § 119 of Germany Patent Application No. DE 10 2025 101 470.1 filed on Jan. 16, 2025, which is expressly incorporated herein by reference in its entirety.

### FIELD

The present disclosure relates to a method for operating an internal combustion engine with gaseous fuel, to a computer program product and to a control unit.

### BACKGROUND INFORMATION

Germany Patent Application No. DE 10 2021 210 001 A1 describes a method for operating an internal combustion engine that uses gaseous fuel, for example hydrogen. Air is supplied to a plurality of combustion chambers. Gaseous hydrogen is injected directly into the combustion chambers, or it is injected into the intake channels (port fuel injection), and the hydrogen-air mixture is ignited in the combustion chambers.

### BACKGROUND INFORMATION

The present disclosure provides a method, and by a computer program product, and a control unit. Advantageous developments and example embodiments are disclosed herein.

An advantage of the present disclosure includes that, despite the continuous replenishment of gaseous fuel into the fuel rail, the fuel mass actually withdrawn from the fuel rail during an injection of fuel into a combustion chamber, or at least a variable characterizing said fuel mass, can be detected, as a result of which, for example, a malfunction of a fuel injector can be diagnosed and, if applicable, corrected. This is achieved through method steps that are easy to implement in software, without the need for additional sensors.

Specifically, according to an example embodiment, this is achieved through a method for operating an internal combustion engine having a plurality of combustion chambers, in which gaseous fuel from a fuel rail is supplied by means of injection to a combustion chamber via a fuel injector assigned to a particular combustion chamber. The internal combustion engine can be constructed in a very similar way to conventional 4-stroke piston internal combustion engines that use liquid fuel in the form of diesel or gasoline. The gaseous fuel can be, for example, hydrogen. The fuel injectors can inject the gaseous fuel directly into their respectively assigned combustion chambers, or they can inject the gaseous fuel into an intake channel assigned to the respective combustion chamber. In both cases, the fuel injectors are fluidically connected to a common fuel rail, which supplies the fuel injectors with gaseous fuel at a specified pressure level. The fuel rail can be a typical, for example tubular, fuel manifold as from gasoline and diesel internal combustion engines with direct injection.

Between an injection for one combustion chamber and a subsequent injection for another combustion chamber, there can be, at least temporarily, a pause, i.e., a time period during which no injection is carried out. However, such a pause need not be present, or need not always be present. For example, it can be present at least at one “typical” operating point of the internal combustion engine. Gaseous fuel is supplied to the fuel rail substantially continuously from a fuel supply system. Thus, the gaseous fuel is also supplied during the withdrawal phases, in which fuel is injected. It is understood that the amount of supplied fuel can be varied according to the amount withdrawn by the fuel injectors. The method according to the present disclosure is particularly preferably performed when the internal combustion engine is in at least a more or less steady-state, or at least not overly dynamic, operating state, i.e., load and rotational speed do not change, or at least do not change significantly, and thus the mass of the fuel supplied to the fuel rail and the mass of fuel withdrawn from the fuel rail by the fuel injectors also do not change, or at least do not change substantially.

According to the present disclosure, an example embodiment of the method initially comprises the following step: (a) ascertaining, within at least one operating cycle, the pressure drops of the pressure in the fuel rail that respectively occur during an injection into a combustion chamber. In a typical four-stroke internal combustion engine, an operating cycle comprises an intake stroke, a compression stroke, a power stroke and an exhaust stroke, and lasts two crankshaft revolutions. The pressure drops (reduction Δp of the pressure p) in the fuel rail are ascertained within the operating cycle for each injection into a combustion chamber. In an internal combustion engine with four cylinders and thus with four combustion chambers and one injection per combustion chamber, four pressure drops thus occur within an operating cycle, the value of which pressure drops is ascertained directly or indirectly.

This is based on the consideration that, in contrast to injection systems with liquid fuels (e.g., gasoline, diesel), in an internal combustion engine with gaseous fuel, the regulation of the pressure in the fuel rail is carried out not via a (piston) pump that replenishes discontinuously, but via continuous replenishment by a suitable pressure regulator that is supplied from a high-pressure gas reservoir. The replenishment can typically be regarded as constant to a good approximation and, over a complete operating cycle of the internal combustion engine, it typically corresponds exactly to the sum of all gas quantities withdrawn via the fuel injectors. With one injection per cylinder per operating cycle, a profile of the pressure in the fuel rail results that, in the ideal case, would correspond to a regular sawtooth pattern. The rising edges of the sawtooth pattern result from the continuous and constant replenishment, and the falling edges of the sawtooth pattern result from a superposition of withdrawal of the gaseous fuel and simultaneous replenishment. The falling edges define the above-mentioned pressure drop of the pressure in the fuel rail for a particular combustion chamber.

The method according to the present disclosure further comprises, as step (b), ascertaining the open durations, assigned to a particular pressure drop, of the corresponding fuel injector. The open duration is the time period during which the fuel injector is open and allows gaseous fuel to be supplied to the combustion chamber assigned to this fuel injector. The open duration of a fuel injector can, for example, be ascertained either via the actuation of the fuel injector, or it can be ascertained from the beginning and the end of the pressure drop. The points of time of “opening” and “closing,” and thus the actual open duration, can also be ascertained by evaluating electrical signals (current, voltage) during or after the actuation of the fuel injector.

Furthermore, the method according to the present disclosure comprises, as step (c), ascertaining the total duration of the operating cycle. This total duration is the time period that the crankshaft requires for two crankshaft revolutions. For this purpose, it is possible, for example, to use the signal of a sensor that detects a position of a crankshaft or a camshaft of the internal combustion engine, so that, from this signal, the time period can be ascertained within which the crankshaft has executed two complete revolutions. However, the total duration of the operating cycle can also be ascertained, for example, from a rotational speed signal of the crankshaft.

Finally, the method according to the present disclosure further comprises, as step (d), ascertaining respective mass indicators from the ascertained pressure drops, the ascertained open durations and the ascertained total duration. Such a mass indicator typically does not correspond to the exact mass of gaseous fuel that the particular fuel injector has injected into the assigned combustion chamber within an operating cycle. Instead, it is typically a value that is applicable to a fuel injector or to a combustion chamber and that, by comparison with the values applicable to the other fuel injectors or combustion chambers, makes it possible to perform the above-mentioned diagnosis and, if applicable, correction.

According to the present disclosure, it was recognized that, without replenishment, the pressure in the fuel rail would drop proportionally with the mass withdrawn/injected by a fuel injector, and the pressure gradient of the pressure drop would drop proportionally with the flow rate according to the actual flow cross-section and the open duration. However, due to the continuous replenishment of the gaseous fuel into the fuel rail, pressure drops and pressure gradients result that are no longer proportional to the injected quantities or masses or the respective flow rates. This problem is solved by the mass indicators ascertained according to the present disclosure.

At this point, it should be noted that, here and in the following, the terms “pressure drop,” “pressure gradient,” “fuel mass,” “open duration,” and “total duration,” when physically meaningful and possible, can also contain corresponding variables characterizing these terms, for example dimensionless variables. It should also be noted at this point that, in practice, the terms “fuel quantity” and “fuel mass” are often used synonymously, or the fuel quantity often characterizes the fuel mass.

In a development of the present disclosure, it is provided that the mass indicators are the quotient of the fuel mass injected into a respective combustion chamber and a constant. This results from the physical fact that pressure and mass are proportional to each other. The corresponding proportionality constant does not have to be known for the comparison, provided according to the present disclosure, of the mass indicators of the respective combustion chambers or fuel injectors since it is the same for all combustion chambers or fuel injectors. This makes the method according to the present disclosure very simple.

In a development of the present disclosure, it is provided that the pressure drop of the pressure in the fuel rail occurring during an injection into a particular combustion chamber is ascertained from a pressure gradient of the pressure in the fuel rail occurring during this injection and an open duration of the fuel injector used for this injection. Compared to a direct determination or detection, such an ascertainment of the pressure drop has the advantage that influences from measurement noise, any signal smoothing that may be present, and typically present discrete sampling points in time can be reduced. Therefore, the method is even more accurate and more meaningful.

In a development of the present disclosure, it is provided that the pressure gradient is ascertained either using the pressure and the point in time at the beginning of an injection and the pressure and the point in time at the end of the injection, or that the pressure gradient is ascertained as an average value of pressure gradients between the beginning of an injection and the end of the injection, or that the pressure gradient is ascertained as an average value of pressure gradients during a partial time period between the beginning of an injection and the end of the injection, or that the pressure gradient is ascertained using the maximum pressure gradient in the time period between the beginning of an injection and the end of the injection. All these variations can be easily implemented from a software perspective.

In a development of the present disclosure, it is provided that an actuation of the fuel injectors is corrected on the basis of the mass indicators ascertained for the fuel injectors, in such a way that the mass indicators within an operating cycle have at least approximately the same value. This is based on the consideration that, due to manufacturing variations in the production of the fuel injectors and due to wear over their service life, it can occur that the fuel injectors do not meter the fuel exactly equally. Thus, without correction, different metering by the fuel injectors of the individual cylinders or combustion chambers of the internal combustion engine occurs. This results in particular from differences in switching behavior (opening/closing) and/or from differences in steady-state flow, for example due to a change in the opening width of the inlet opening of the fuel injector. With different metering of the fuel into the combustion chambers, the combustion of the fuel generates a different torque depending on the combustion chamber, as a result of which smooth running of the internal combustion engine can be impaired. Furthermore, unwanted emissions may occur. Due to the correction provided according to the present disclosure, an “equalization” is achieved, i.e., ultimately, despite qualitatively different fuel injectors, a substantially equal fuel quantity or fuel mass is injected into all combustion chambers. As a result, smooth running and emissions of the internal combustion engine are improved.

In a development of the present disclosure, it is provided that, when it is ascertained that the differences of the values of the mass indicators are caused at least also by flow deviations, the actuation comprises a multiplicative correction. These flow deviations can be caused, for example, by different opening widths of the inlet openings of the fuel injectors. These flow deviations can be corrected particularly well by the multiplicative correction provided according to the present disclosure (increasing or decreasing the open duration by a multiplicative factor).

In a development of the present disclosure, it is provided that, when it is ascertained that the differences of the values of the mass indicators are caused at least also by different opening and closing, the actuation comprises an additive correction. These flow deviations can be caused, for example, by different behavior of the actuators of the fuel injectors. Such flow deviations can be corrected particularly well by the additive correction provided according to the present disclosure (increasing or decreasing the open duration by a fixed offset).

In principle, the correction can be adapted continuously during operation of the internal combustion engine, so that a closed control loop is formed by which the deviations are reduced continuously. However, in a development, it is provided that the mass indicators of a plurality of operating cycles are used for ascertaining an averaged correction, which can then be applied, for example, after a restart of the internal combustion engine.

The present disclosure also relates to a computer program product comprising commands that, when the program is executed by a computer, cause the computer to execute a method of the type described above.

The present disclosure also relates to a control unit for controlling and/or regulating the operation of an internal combustion engine, comprising at least one processor, at least one memory and at least one computer program product of the type just described that is stored in the memory. The control unit can also be referred to as a computer.

Example embodiments of the present disclosure are explained below with reference to the figures.

### BRIEF DESCRIPTION OF THE DRAWINGS

FIG. 1 is a schematic representation of an internal combustion engine with six combustion chambers, in which gaseous fuel is injected from a fuel rail by means of fuel injectors directly into a respective combustion chamber.

FIG. 2 is a diagram in which a profile of a pressure in the fuel rail of FIG. 1 is plotted over time for injections into all six combustion chambers of FIG. 1.

FIG. 3-7 are diagrams similar to FIG. 2, but only for one injection, for explaining different methods for ascertaining a pressure gradient, according to example embodiments of the present disclosure.

FIG. 8 is a bar chart in which mass indicators for the combustion chambers of FIG. 1 are plotted, without correction of the actuation of the fuel injectors.

FIG. 9 is a bar chart similar to FIG. 8, but with correction of the actuation of the fuel injectors, according to an example embodiment of the present disclosure.

FIG. 10 is a diagram in which the pressure in the fuel rail of an alternative internal combustion engine with only four combustion chambers is plotted over time, without correction of the actuation of the fuel injectors.

FIG. 11 is a diagram similar to FIG. 10, but with correction of the actuation of the fuel injectors, according to an example embodiment of the present disclosure.

FIG. 12 is a flowchart of a method for operating the internal combustion engine of FIG. 1, with correction of the actuation of the fuel injectors, according to an example embodiment of the present disclosure.

### DETAILED DESCRIPTION OF EXAMPLE EMBODIMENTS

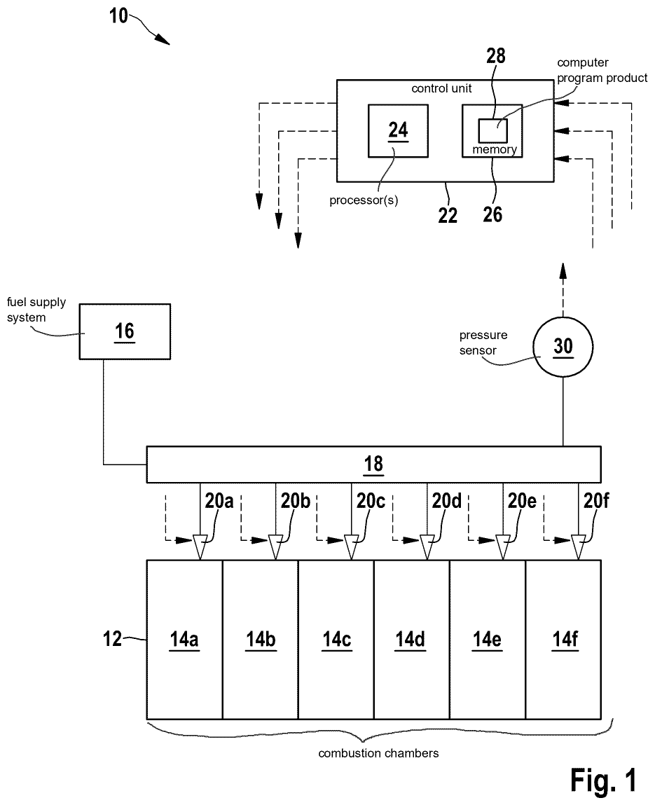

An internal combustion engine is designated overall by reference sign 10 in FIG. 1. It comprises an engine block 12 with, by way of example in the present case, six combustion chambers 14a-f. Furthermore, the internal combustion engine 10 comprises a fuel supply system 16, which supplies gaseous fuel to a fuel rail 18. By way of example in the present case, six fuel injectors 20a-f are connected to the fuel rail 18. Each fuel injector 20a-f is assigned to a combustion chamber 14a-f. This makes it possible for the fuel injector 20a to inject the gaseous fuel individually for the combustion chamber 14a, for the fuel injector 20b to inject the gaseous fuel individually for the combustion chamber 14b, etc. This can be implemented in that the fuel injectors 20a-f, as shown by way of example in the present case, inject the gaseous fuel directly into the respectively assigned combustion chambers 14a-f. In an embodiment not shown, this can be implemented in that the fuel injectors inject the gaseous fuel into an intake channel of a respective combustion chamber.

Each fuel injector 20a-f has an actuator (not shown), which can be, for example, an electromagnetic actuator or a piezoelectric actuator. By means of this actuator, a valve element (not shown), which is often needle-like, can be switched, for an injection, from a closed position to an open position and back again. For this purpose, each fuel injector 20a-f is actuated separately, which is indicated by respective dashed arrows.

For actuating, inter alia, the fuel injectors 20a-f, a control unit 22 is provided, which comprises at least one processor 24, at least one memory 26, and at least one computer program product 28 stored in the memory 26. The control unit 22 can also be referred to as a computer or can comprise such a computer. The computer program product 28 comprises commands that, when the program is executed on the processor 24, cause the control unit 22 to execute certain method steps corresponding to the computer program product 28, as described below. The internal combustion engine 10 also includes a pressure sensor 30, which detects the pressure of the gaseous fuel in the fuel rail 18 with high temporal resolution and provides a corresponding signal to the control unit 22.

In the present case, the internal combustion engine 10 is a typical four-stroke internal combustion engine, in which each operating cycle comprises the usual four strokes “intake stroke,” “compression stroke,” “power stroke,” and “exhaust stroke.” Two complete revolutions of the crankshaft are required for a complete operating cycle of all combustion chambers of such an internal combustion engine 10. The gaseous fuel is typically injected into a combustion chamber during the intake stroke and/or the compression stroke.

Due to manufacturing variations in the production of the fuel injectors 20a-f and due to changes over the service life (for example wear), the fuel injectors 20a-f do not meter the fuel exactly equally if no countermeasures are taken. Without corresponding countermeasures, a deviation in the metering across the combustion chambers 14a-f of the internal combustion engine 10 unavoidably occurs, resulting from differences in switching behavior and/or in steady-state flow. The differences in switching behavior are manifested, for example, in different opening times and/or closing times, for example due to manufacturing tolerances of the actuators. The differences in steady-state flow can be caused, for example, by different opening widths of the outlet openings of the fuel injectors. All of this can lead to rough engine running, undesired pollutant emissions, in particular NOx, efficiency deterioration with increased consumption, and even engine damage, for example due to knocking combustion.

It is therefore desirable to correct the actuation of the fuel injectors 20a-f by the control unit 22 such that, at least in a steady-state operation of the internal combustion engine 10 over an operating cycle in which fuel is injected once sequentially into each combustion chamber 14a-f (optionally also divided into a plurality of partial injections), the same quantity of fuel reaches each combustion chamber 14a-f. A method for such a correction is now explained:

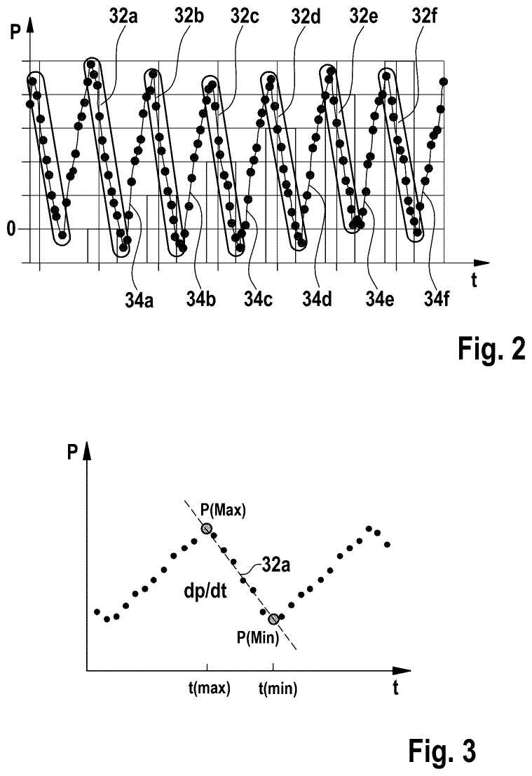

Due to the sequential withdrawal of fuel from the fuel rail 18 by the fuel injectors 20a-f, with simultaneous parallel and continuous replenishment of fuel from the fuel supply system 16 into the fuel rail 18, a sawtooth pattern of the pressure profile in the fuel rail 18 is produced. This profile is measured by the pressure sensor 30. The-uncorrected-pressure profile is reproduced in FIG. 2. Falling edges bear the reference signs 32a-f, and rising edges bear the reference signs 34a-f. Falling edges 32a-f are generated by the respective injections into the combustion chambers 14a-f and the simultaneous continuous replenishment of fuel from the fuel supply system 16. Rising edges 34a-f characterize the pauses following a respective injection 32a-f into a combustion chamber 14a-f, during which no fuel is withdrawn from the fuel rail 18 via the fuel injectors 20a-f and instead fuel is supplied exclusively and continuously from the fuel supply system 16 into the fuel rail 18.

In the present case, the falling edges 32a-f are used to ascertain a pressure drop that is caused by the withdrawal of the gaseous fuel by the respective injection. For this purpose, by way of example in the present case, a pressure gradient dp/dt is first ascertained, namely the magnitude of the (negative) slope of the falling edge 32a-f. In FIG. 3-7, various options are illustrated for the falling edge 32a associated with the combustion chamber 14a, by means of which this pressure gradient dp/dt can be ascertained.

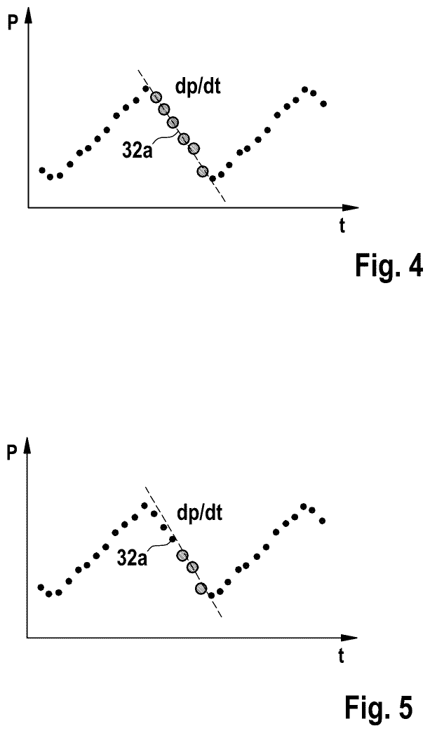

According to FIG. 3, the pressure gradient dp/dt is ascertained using the pressure p(min) and the point in time t(min) at the end of an injection 32a and the pressure p(max) and the point in time t(max) at the beginning of the injection 32a by simply forming the difference, (p(max)−p(min))/(t(max)−t(min)). According to FIG. 4, the pressure gradient dp/dt is ascertained as an average value of a plurality of pressure gradients dp/dt ascertained at discrete points between the beginning and the end of the injection 32a, for example on the basis of the measured pressure signal via a linear fit or a digital filter (IIR, FIR or a combination thereof). The input values are thus the pressure values as a raw signal, and the output values are the pressure gradient.

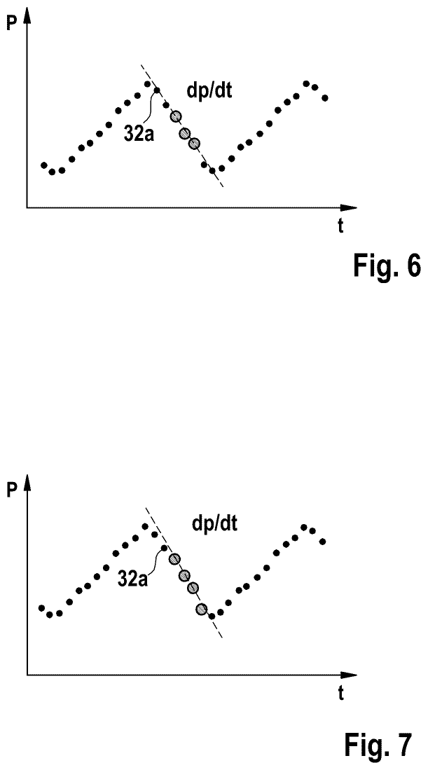

According to FIG. 5-7, the pressure gradient dp/dt is ascertained as an average value (for example an arithmetic mean) of local pressure gradients during a partial time period between the beginning and the end of the injection 32a, namely according to FIG. 5 shortly before the end, according to FIG. 6 during a partial time period approximately in the middle between the beginning and the end, and according to FIG. 7 at that point in time during the injection 32a at which the falling edge has the maximum magnitude of slope. It is possible that the pressure gradient dp/dt for each fuel injector 20a-f is ascertained during a plurality of injections 32a, 32b, 32c, etc., for example during a plurality of immediately successive operating cycles, and that an average value is then formed therefrom, for example an arithmetic mean.

From the pressure gradient dp/dt and an open duration T_{open,n} that is individual for a fuel injector 20n (with n=a−f by way of example in the present case), the pressure drop Δpₙ for each fuel injector 20n or each injection 32n can be determined. In this manner, by way of example in the present case, six pressure drops Δpₙ are calculated over one operating cycle of the internal combustion engine 10. Since the gaseous fuel is supplied continuously to the fuel rail 18 and, at least over one operating cycle, an at least substantially constant delivery rate can be assumed, a balanced mass balance must exist under (quasi-)constant operating conditions between, on the one hand, the replenishment of gaseous fuel into the fuel rail 18 and, on the other hand, the withdrawal of gaseous fuel from the fuel rail 18 by the fuel injectors 20a-f and the injections 32a-f, in accordance with the following formula:

Injected fuel mass mₙ during an injection 32a-f per fuel injector 20a-f:

$${m}_{n} = d {m}_{n} / dt \cdot {T}_{open , n} \qquad ( 1 )$$

Fuel mass supplied to the fuel rail 18 during one operating cycle:

$${Σ}_{k = a - f} {m}_{k} = {T}_{ASP} \cdot d {m}_{D R} / d t \qquad ( 2 )$$

n=a-f for fuel injectors 20a-f and injections 32a-f
mₙ=fuel mass injected by a fuel injector 20n during an injection 32n
dmₙ/dt=flow rate (mass per time) from a fuel injector 20n during an injection 32n into the combustion chamber 14n
T_{open,n}=open duration of the fuel injector 20n during an injection 32n
dm_{DR}/dt=flow rate (mass per time) of fuel into the fuel rail 18
T_{ASP}=duration of the operating cycle

Since pressure and quantity are proportional to one another, the pressure drop Δpₙ during an injection 32n for a fuel injector 20n results, with a conversion factor α (proportionality constant), as follows:

$$\begin{matrix}α \cdot {p}_{n} = ( d {m}_{n} / dt - d {m}_{D R} / dt ) \cdot {T}_{open , n} \\ = ( {m}_{n} / {T}_{open , n} - {Σ}_{k = a - f} {m}_{k} / {T}_{ASP} ) \cdot {T}_{open , n} \\ = {m}_{n} - {Σ}_{k = a - f} {m}_{k} \cdot {T}_{open , n} / {T}_{A S P}\end{matrix} \qquad ( 3 )$$

This results in:

$$\begin{matrix}Δ {p}_{n} = {m}_{n} / α - {Σ}_{k = a - f} {m}_{k} / α \cdot {T}_{open , n} / {T}_{ASP} \\ = {I}_{n} - {Σ}_{k = a - f} {m}_{k} \cdot {T}_{open , n} / {T}_{ASP} or\end{matrix} \qquad ( 4 )$$

$${I}_{n} = Δ {p}_{n} + {Σ}_{k = a - f} {I}_{k} \cdot {T}_{open , n} / {T}_{ASP} \qquad ( 5 )$$

Iₙ is a mass indicator for the particular fuel injector 20n. This provides, for each fuel injector 20n, information as to via which fuel injector 20a-f more or less fuel mass is withdrawn than the average across all fuel injectors 20a-f. In equation (5), only the known variables T_{open,n}, T_{ASP} and Δpₙ and the initially still unknown mass indicators Iₙ=mₙ/α remain. If the system of equations, which by way of example in the present case consists of six equations (for the fuel injectors 20a-f), is solved for the mass indicators Iₙ, the values for the mass indicators Iₙ are obtained.

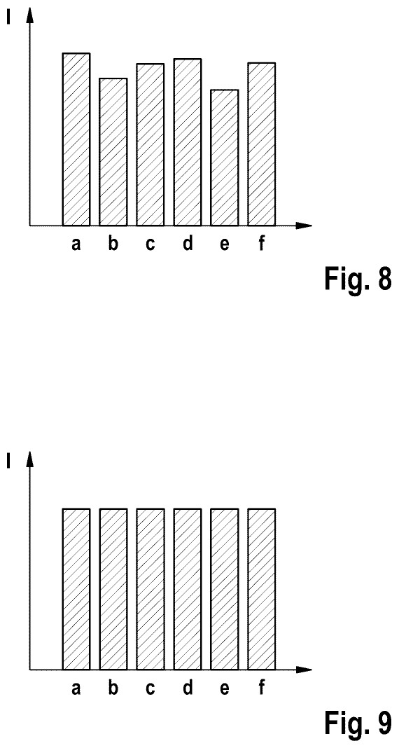

The corresponding mass indicators I_{a-f} are plotted as a bar chart in FIG. 8. FIG. 8 shows the mass indicators I_{a-f} without correction of the actuation of the fuel injectors 20a-f.

For a correction, for example, the arithmetic mean of the mass indicators I_{a-f} can be ascertained, and the deviations of the individual mass indicators I_{a-f} from the arithmetic mean value can then be calculated. On the basis of these deviations, correction values for the actuation of the fuel injectors 20a-f by the control unit 22 can now be ascertained, which lead to the mass indicators I_{a-f} all having the same magnitude, as shown in FIG. 9. This means that all fuel injectors 20a-f supply at least approximately the same mass of fuel to the respective combustion chambers 14a-f during one operating cycle under steady-state operating conditions of the internal combustion engine 10.

If the differences in the injected masses are based on flow deviations of the fuel injectors 20a-f (so-called “Qstat differences”), a multiplicative correction is meaningful. If the differences in the injected masses are caused by different opening and closing, an additive correction is more advantageous. The corrections can be adjusted continuously so that a closed control loop is formed which reduces the deviations. Alternatively, it is also possible initially to only observe the mass indicators Ia-f over a longer period of time and subsequently to calculate and apply a correction averaged over the observation period, for example an arithmetic mean, e.g., upon a restart of the internal combustion engine 10.

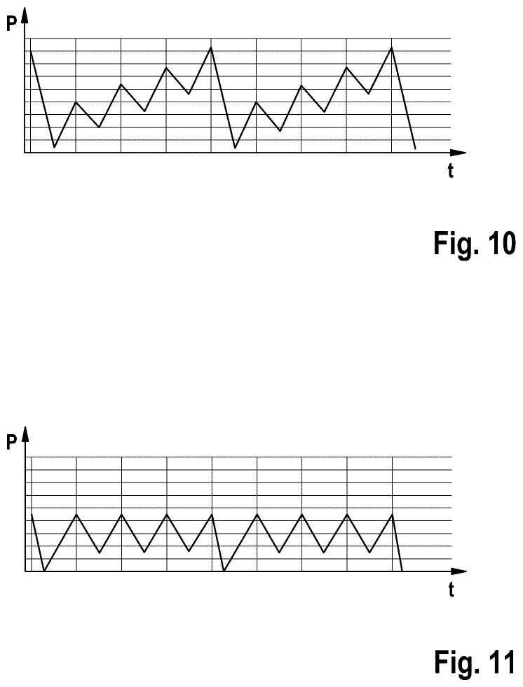

FIG. 10 shows a pressure/time diagram of the pressure p in a fuel rail of a four-cylinder internal combustion engine before a correction, and FIG. 11 shows a pressure/time diagram of the pressure in a fuel rail of a four-cylinder internal combustion engine after such a correction. It can be recognized that a steady-state flow deviation is present in the fuel injector that causes a pressure change last in the diagram.

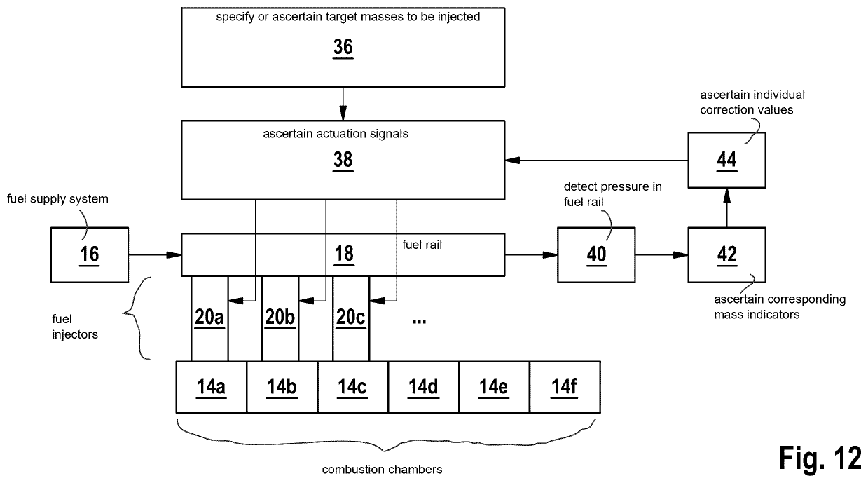

For the sake of completeness, the method described above for ascertaining the mass indicators I_{a-f} is now also explained with reference to the flowchart of FIG. 12:

In a function block 36, the target masses to be injected during an injection are specified or ascertained for each fuel injector 20a-f, for example taking into account the rotational speed of the internal combustion engine 10 and a load demand by a user, i.e., taking into account a desired torque. Based on this, inter alia, the actuation signals for the fuel injectors 20a-f are ascertained in a function block 38 on the basis of their nominal behavior, i.e., an ideal flow rate and ideal switching dynamics. The fuel injectors 20a-f are initially actuated with these control signals. By means of the pressure sensor 30, the pressure in the fuel rail 18 is detected with high accuracy and high temporal resolution in a function block 40. In a function block 42, the corresponding mass indicators I_{a-f} are ascertained for each fuel injector 20a-f in accordance with the method described above. Therefrom, individual correction values are ascertained for each fuel injector 20a-f in a function block 44, with the aim that the mass indicators I_{a-f} all have the same value. The correction values ascertained in function block 44 are then also fed into the function block 40 so that the fuel injectors 20a-f are actuated with correspondingly adapted control signals.

What is claimed is:

1. A method for operating an internal combustion engine having a plurality of combustion chambers, in which gaseous fuel is supplied using an injection from a fuel rail and via a fuel injector assigned to a particular combustion chamber, and in which gaseous fuel is supplied to the fuel rail substantially continuously from a fuel supply system, the method comprising the following steps:
ascertaining, within at least one operating cycle, respective pressure drops of the pressure in the fuel rail that respectively occur during an injection into the corresponding combustion chambers of the combustion chambers;
ascertaining open durations, assigned to each of the respective pressure drops, of the corresponding fuel injectors;
ascertaining a total duration of the operating cycle;
ascertaining respective mass indicators from the ascertained pressure drops, the ascertained open durations, and the ascertained total duration.

2. The method according to claim 1, wherein the mass indicators are each a quotient of the fuel mass injected into a respective combustion chamber of the combustion chambers and a constant.

3. The method according to claim 1, wherein the pressure drop of the pressure in the fuel rail occurring during a respective injection into a respective combustion chamber of the combustion chambers is ascertained from a pressure gradient of the pressure in the fuel rail occurring during the respective injection and the open duration of the fuel injector used for the respective injection.

4. The method according to claim 3, wherein the pressure gradient is ascertained: (i) using the pressure in the fuel rail and a point in time at the beginning of the respective injection and the pressure and the point in time at an end of the respective injection, or (ii) as an average value of pressure gradients between the beginning of the respective injection and the end of the respective injection, or (iii) an average value of pressure gradients during a partial time period between the beginning of the respective injection and the end of the respective injection, or (iv) using a maximum pressure gradient in a time period between the beginning of the respective injection and the end of the respective injection.

5. The method according to claim 1, wherein an actuation of the fuel injectors is corrected based on the mass indicators ascertained for the fuel injectors, in such a way that the mass indicators within an operating cycle have at least approximately a same value.

6. The method according to claim 5, wherein, when it is ascertained that differences of values of the mass indicators are caused at least also by flow deviations, the actuation includes a multiplicative correction.

7. The method according to claim 5, wherein, when it is ascertained that differences of values of the mass indicators are caused at least by different opening and closing times, the actuation includes an additive correction.

8. The method according to claim 5, wherein the mass indicators of a plurality of operating cycles are used for ascertaining an averaged correction.

9. A non-transitory computer-readable medium on which is stored a computer program including commands for operating an internal combustion engine having a plurality of combustion chambers, in which gaseous fuel is supplied using an injection from a fuel rail and via a fuel injector assigned to a particular combustion chamber, and in which gaseous fuel is supplied to the fuel rail substantially continuously from a fuel supply system, the commands, when executed by a computer, causing the computer to perform the following steps:
ascertaining, within at least one operating cycle, respective pressure drops of the pressure in the fuel rail that respectively occur during an injection into the corresponding combustion chambers of the combustion chambers;
ascertaining open durations, assigned to each of the respective pressure drops, of the corresponding fuel injectors;
ascertaining a total duration of the operating cycle;
ascertaining respective mass indicators from the ascertained pressure drops, the ascertained open durations, and the ascertained total duration.

10. A control unit for controlling and/or regulating the operation of an internal combustion engine, the control unit comprising:
at least one processor;
at least one non-transitory memory in which is stored a computer program including commands for operating the internal combustion engine which has a plurality of combustion chambers, in which gaseous fuel is supplied using an injection from a fuel rail and via a fuel injector assigned to a particular combustion chamber, and in which gaseous fuel is supplied to the fuel rail substantially continuously from a fuel supply system, the commands, when executed by a computer, causing the computer to perform the following steps:
ascertaining, within at least one operating cycle, respective pressure drops of the pressure in the fuel rail that respectively occur during an injection into the corresponding combustion chambers of the combustion chambers;
ascertaining open durations, assigned to each of the respective pressure drops, of the corresponding fuel injectors;
ascertaining a total duration of the operating cycle;
ascertaining respective mass indicators from the ascertained pressure drops, the ascertained open durations, and the ascertained total duration.
